(19) United States
(12) Patent Application Publication
(10) Pub. No.: US 2011/0235637 A1
(43) Pub. Date: Sep. 29, 2011

(54) METHOD AND APPARATUS FOR IMPROVED NETWORK SWITCH MULTICAST FUNCTIONALITY

(75) Inventors: Gregory Herlein, San Francisco, CA (US); Christopher Yunker, Portland, OR (US); Kelly Hoinacki, Mill Valley, CA (US)

(73) Assignee: THOMAS LICENSING, Boulogne-Billancourt (FR)

(21) Appl. No.: 12/998,790

(22) PCT Filed: Dec. 19, 2008
(86) PCT No.: PCT/US2008/013875

§ 371 Date: Jun. 1, 2011

(51) Int. Cl. H04L 12/56

(52) U.S. Cl. 370/390

(57) ABSTRACT

A method in a network switch for improved multicast functionality includes receiving information regarding for which group or groups of receivers content is intended, comparing the received information with stored information regarding which receivers belong to which group or groups of receivers to identify receivers belonging to the group or groups of receivers for which the content is intended and multi-casting the content to the identified receivers. In one embodiment, the group or groups of receivers are pre-established using a device group control protocol and are distinguished using a unique identifier for each group. In an alternate embodiment, the group or groups of receivers are established by the network switch.

### CROSS-REFERENCE TO RELATED APPLICATIONS

This application is related to U.S. Patent Provisional Application No. 60/921714, filed on Apr. 04, 2007 in the USPTO and International Patent Application serial no. PCT/US07/013949, filed on Jun. 13, 2007 in the PCT and claiming priority to the U.S. Patent Provisional Application No. 60/921714, both entitled “Device Group Control”, which are hereby incorporated by reference in their entireties.

### FIELD OF THE INVENTION

The present invention generally relates to network switches and, more particularly, to a method and apparatus for improving multicast functionality of network switches.

### BACKGROUND OF THE INVENTION

Multicast network traffic or content traversing a network switch is commonly forwarded to all the physical ports of the switch. Such a configuration creates a high degree of traffic across all of the ports and presents a high network traffic load to devices attached to the ports.

As such, some advanced network switches support Internet Group Management Protocol (IGMP) ‘sniffing’ or ‘snooping’ to address such traffic issues. This technique enables a network switch to refrain from forwarding received multicast traffic to a port until it is positively determined that a device attached to that port is supposed to receive the multicast traffic. In such techniques, by monitoring the IGMP protocol, the network switch can determine when to begin forwarding the multicast traffic to a specific physical port. That is, in such techniques, the network switch waits for a port device to issue a command, such as an ‘IGMP’ join command, before forwarding received multicast traffic.

Such solutions, however, create latency between the time a port device is ready to receive multicast traffic and when the traffic begins to be forwarded by the network switch.

### SUMMARY OF THE INVENTION

Embodiments of the present invention address the deficiencies of the prior art by providing a method and apparatus for improved network switch multicast functionality.

In one embodiment of the present invention, method for improved multicast functionality in a network switch includes receiving information regarding for which group or groups of receivers content is intended, comparing the received information with stored information regarding which receivers belong to which group or groups of receivers to identify receivers belonging to the group or groups of receivers for which the content is intended, and multicasting the content to the identified receivers. In one embodiment of the present invention, the group or groups of receivers can be pre-established using, for example, a device group control protocol in which each group can be distinguished using a unique identifier. In an alternate embodiment, the group or groups of receivers can be established by the network switch for improving multicast functionality.

In an alternate embodiment of the present invention, an apparatus for improved multicast functionality includes a network switch for communicating received content to intended receivers, and a device for storing information regarding a grouping or groupings of receivers and which receivers belong to which group or groups of receivers. In such an embodiment, the apparatus is configured to receive information regarding for which group or groups of receivers content is intended, to compare the received information with the stored information to identify receivers belonging to the group or groups of receivers for which the content is intended, and to multicast the content to the identified receivers.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a content distribution system in accordance with an embodiment of the present invention;

FIG. 2 depicts a high level block diagram of an in-store advertising network for providing in-store advertising in accordance with an embodiment of the present invention;

FIG. 3 depicts a high level block diagram of a DGCP device in accordance with an embodiment of the present invention;

FIG. 4 depicts an example sequence diagram for using a prior art IGMP enabled switch;

FIG. 5 depicts an example sequence diagram for using an improved multicast network switch in accordance with an embodiment of the present invention; and

FIG. 6 depicts a flow diagram of a method for an improved multicast network switch in accordance with an embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention advantageously provides a method and apparatus for improved network switch multicast functionality. Although the present invention will be described primarily within the context of a retail advertising network environment, the specific embodiments of the present invention should not be treated as limiting the scope of the invention. It will be appreciated by those skilled in the art and informed by the teachings of the present invention that the concepts of the present invention can be advantageously applied in substantially any broadcast environment for the distribution/multicasting of content.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

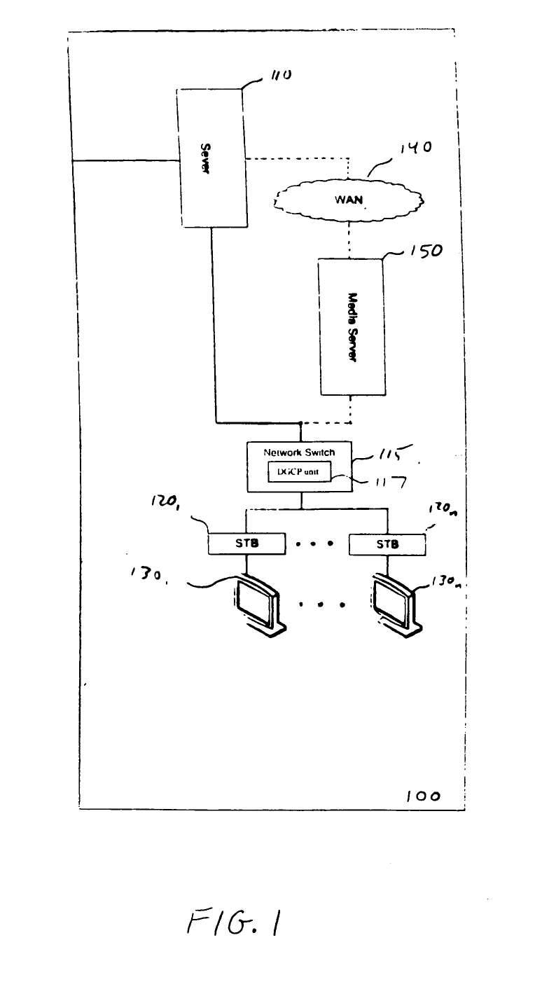

FIG. 1 depicts a high level block diagram of a content distribution system 100 in which an embodiment of the present invention can be applied. The content distribution system 100 of FIG. 1 illustratively comprises at least one server 110, a network switch 115, a plurality of receiving devices such as tuning/decoding means (illustratively set-top boxes (STBs)) 120₁-120ₙ, and a respective display 130₁-130ₙ for each of the set-top boxes 120₁-120ₙ. The content distribution system 100 of FIG. 1 further includes an optional wide-area-network (WAN) 140, an optional media server 150.

Although in the system 100 of FIG. 1, each of the plurality of set-top boxes 120₁-120ₙ, is illustratively connected to a single, respective display, in alternate embodiments of the present invention, each of the plurality of set-top boxes 120₁-120ₙ, can be connected to more than a single display. In addition, although in the content distribution system 100 of FIG. 1 the tuning/decoding means are illustratively depicted as set-top boxes 120, in alternate embodiments of the present invention, the tuning/decoding means of the present invention can comprise alternate tuning/decoding means such as a tuning/decoding circuit integrated into the displays 130 or other stand alone tuning/decoding devices and the like. Even further, receiving devices of the present invention can include any devices capable of receiving content such as text, audio, video and/or audio/video content and in one embodiment can include speaker systems for receiving distributed audio.

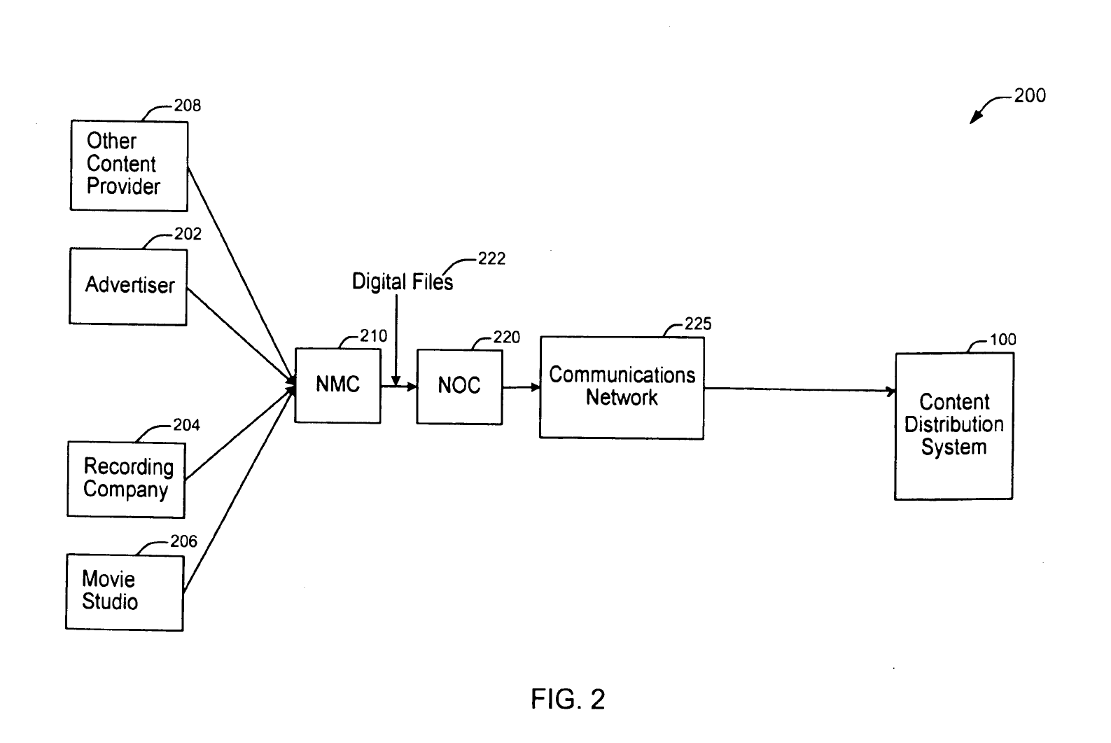

In one embodiment of the present invention, the content distribution system 100 of FIG. 1 can be a part of an in-store advertising network. For example, FIG. 2 depicts a high level block diagram of an in-store advertising network 200 for providing in-store advertising. In the advertising network 200 of FIG. 2, the advertising network 200 and distribution system 100 employ a combination of software and hardware that provides cataloging, distribution, presentation, and usage tracking of music recordings, home video, product demonstrations, advertising content, and other such content, along with entertainment content, news, and similar consumer informational content in an in-store setting. The content can include content presented in compressed or uncompressed video and audio stream format (e.g., MPEG2, MPEG4/MPEG4 Part 10/AVC-H.264, VC-1, Windows Media, etc.), although the present system should not be limited to using only those formats.

In one embodiment of the present invention, software for controlling the various elements of the in-store advertising network 200 and the content distribution system 100 can include a 32-bit operating system using a windowing environment (e.g., MS-Windows™ or X-Windows operating system) and high-performance computing hardware. The advertising network 200 can utilize a distributed architecture and provides centralized content management and distribution control via, in one embodiment, satellite (or other method, e.g., a wide-area network (WAN), the Internet, a series of microwave links, or a similar mechanism) and in-store modules.

As depicted in FIG. 2, the content for the in-store advertising network 200 and the content distribution system 100 can be provided from an advertiser 202, a recording company 204, a movie studio 206 or other content providers 208. An advertiser 202 can be a product manufacturer, a service provider, an advertising company representing a manufacturer or service provider, or other entity. Advertising content from the advertiser 202 can consist of audiovisual content including commercials, “info-mercials”, product information and product demonstrations, and the like.

A recording company 204 can be a record label, music publisher, licensing/publishing entity (e.g., BMI or ASCAP), individual artist, or other such source of music-related content. The recording company 204 provides audiovisual content such as music clips (short segments of recorded music), music video clips, and the like. The movie studio 206 can be a movie studio, a film production company, a publicist, or other source related to the film industry. The movie studio 106 can provide movie clips, pre-recorded interviews with actors and actresses, movie reviews, “behind-the-scenes” presentations, and similar content.

The other content provider 208 can be any other provider of video, audio or audiovisual content that can be distributed and displayed via, for example, the content distribution system 100 of FIG. 1.

In one embodiment of the present invention, content is procured via the network management center 210 (NMC) using, for example, traditional recorded media (tapes, CD's, videos, and the like). Content provided to the NMC 210 is compiled into a form suitable for distribution to, for example, the local distribution system 100, which distributes and displays the content at a local site.

The NMC 210 can digitize the received content and provide it to a Network Operations Center (NOC) 220 in the form of digitized data files 222. It will be noted that data files 222, although referred to in terms of digitized content, can also be streaming audio, streaming video, or other such information. The content compiled and received by the NMC 210 can include commercials, bumpers, graphics, audio and the like. All files are preferably named so that they are uniquely identifiable. More specifically, the NMC 210 creates distribution packs that are targeted to specific sites, such as store locations, and delivered to one or more stores on a scheduled or on-demand basis. The distribution packs, if used, contain content that is intended to either replace or enhance existing content already present on-site (unless the site's system is being initialized for the first time, in which case the packages delivered will form the basis of the site's initial content). Alternatively, the files may be compressed and transferred separately, or a streaming compression program of some type employed.

The NOC 220 communicates digitized data files 222 to, in this example, the content distribution system 100 at a commercial sales outlet 230 via a communications network 225. The communications network 225 can be implemented in any one of several technologies. For example, in one embodiment of the present invention, a satellite link can be used to distribute digitized data files 222 to the content distribution system 100 of the commercial sales outlet 230. This enables content to easily be distributed by broadcasting (or multicasting) the content to various locations. Alternatively, the Internet can be used to both distribute audiovisual content to and allow feedback from commercial sales outlet 230. Other ways of implementing communications network 225, such as using leased lines, a microwave network, or other such mechanisms can also be used in accordance with alternate embodiments of the present invention.

Referring back to FIG. 1, the server 110 of the content distribution system 100 is capable of receiving content and, accordingly, distribute content in-store to the various receivers such as the set-top boxes 120 and displays 130 and speaker systems (not shown) either by communicating the content directly to the network switch 115 or by communicating the content over the WAN 140 to the media server 150, which then communicates the content to the network switch 115. That is, in one embodiment of the present invention, respective set-top boxes 120 and displays 130 and speaker systems (not shown) can be located at specific locations throughout the sales outlet 230 and respectively configured to display content and broadcast audio pertaining to products located within a predetermined distance from the location of each respective set-top box and display and respective speaker system.

The server 110 of the content distribution system 100 receives content and can create various different content channels of text, audio, video and/or audio/video to be communicated to the various receivers throughout the store. That is, in one embodiment of the present invention, the server 110 receives content, as described above with respect to FIG. 2, and communicates the content to a network switch 115, as described above, such that the network switch 115 can communicate the content to only the intended receivers. For example, in one embodiment of the present invention, a network switch of the present invention, such as the network switch 115 of FIG. 1, is privy to information regarding pre-established groupings of receivers. More specifically, in one embodiment of the present invention, the network switch 115 contains information regarding receivers and their groupings, the receivers being grouped, in one embodiment, according to a Device Group Control Protocol described in a commonly owned Provisional Patent Application Ser. No. 60/921714, filed on Apr. 4, 2007 in the USPTO and an International Patent Application serial no. PCT/US07/013949, filed on Jun. 13, 2007 in the PCT and electing the U.S., both entitled “Device Group Control”, which are hereby incorporated by reference in their entireties.

That is in accordance with the Device Group Control Protocol, a receiver can be configured to belong to at least one group—itself—and can also belong to many other groups. As such, commands or requests can be targeted by group—which can contain one or a plurality of devices. Each device of a group will, as such, transmit and receive using the same broadcast or multicast channel. In various embodiments of the above described invention, devices can support being members of as many groups as desired. In addition, devices can be configured to be members of or not members of groups either by using the protocol or by external means, such as configuration files or other transactions such as (Simple Network Management Protocol) SNMP or web configuration pages. In addition, some applications of the above described invention find it highly desirable to also pre-configure group membership.

Referring back to FIG. 1, in one embodiment of the present invention, the server 110 of the content distribution system 100 receives content and creates various different channels of, for example, text, audio, video and/or audio/video to be distributed to the various devices/ receivers such as the set-top boxes 120 and displays 130 and speaker systems (not shown). In addition to the received content, the server 110 receives instructions and configuration information for determining what specific received content is intended for which specific devices or groups of devices. In accordance with embodiments of the present invention, the network switch 115 receives the content and group information for which group of receivers the content is intended from the server 110 and refers to stored information regarding which receivers belong to which groups to be able to multicast the content to the appropriate receivers or groups of receivers in a more efficient manner.

More specifically and as depicted in FIG. 1, the network switch 115 of the illustrated embodiment of the present invention comprises a device group control protocol (DGCP) device 117. The DGCP device 117 of the network switch 115 of the present invention can be implemented for storing configuration information for use by the network switch 115 in identifying which receivers belong to which groups for multicasting content to the intended receivers and groups of receivers in accordance with, for example, the DGCP protocol.

As such, in accordance with the various embodiments of the present invention, a network switch of the present invention does not suffer from the inefficiencies of prior art techniques which employ Internet Group Management Protocol (IGMP) ‘sniffing’ or ‘snooping’ because such techniques enable a network switch to refrain from forwarding received multicast traffic to a port until it is positively determined that a device attached to that port is supposed to receive the multicast traffic. In such techniques, by monitoring the IGMP protocol, the network switch can determine when to begin forwarding the multicast traffic to a specific physical port. That is, in such techniques, the network switch waits for a port device to issue a command, such as an ‘IGMP’ join command, before forwarding received multicast traffic.

In contrast, a network switch of the present invention is able to determine for which receiver(s) or group(s) of receivers the content is intended by, in one embodiment, referring to a stored list of pre-established groups to which the receivers belong and comparing that stored information to information received, in one embodiment, with content received from the server 110, indicating for which group or groups of receivers the content is intended. That is, when information, such as a unique identifier for identifying a group or groups of receivers for which content is intended, is received by the network switch of the present invention, the network switch refers to stored information, in one embodiment stored in the DGCP device 117, regarding the configuration of the groups of receivers and which receivers belong to the specific groups identified by the unique group identifiers, and multicasts the content to the intended receivers or group(s) of receivers. In accordance with the DGCP protocol, the receivers of the groups, having been pre-established in specific groups, can examine received content and/or streams for the unique identifier of a group to which the receiver(s) belongs, to determine if the content is actually intended for it.

In addition, in various embodiments of the present invention, to improve the efficiency of multicasting of a network switch of the present invention, along with the stored information regarding which receivers belong to which groups, a network switch of the present invention can have associated with the unique group identifiers identifying the groups, information regarding on which ports the various receivers of the groups are connected to the network switch such that when a group and associated receivers are identified, the physical ports on which the receivers of an identified group are connected can also be quickly identified to increase the multicasting efficiency of the various described embodiments of a network switch of the present invention.

For example, suppose that in the content distribution system 100 of FIG. 1 a first set-top box and associated display and a second set-top box and associated display are installed in a Fashion Department of a retail environment. Also suppose that a third set-top box and associated display and a fourth set-top box and associated display are installed in a Food Department of the retail environment. Also suppose that the Fashion Department first set-top box and associated display and a second set-top box and associated display comprise a pre-established group identified as group ID1 and the Food Department third set-top box and associated display and a fourth set-top box and associated display comprise a pre-established group identified as group ID2, when a network switch of the present invention receives content intended for group ID1, identified by information communicated with the content, the network switch examines the information communicated with the content and determines that the content is intended for group ID1. Because the network switch of the present invention contains information identifying which receivers belong to which groups, the network switch determines which receivers belong to group ID1 and, in the above described example, multicasts the content out of a physical port of the network switch on which the first set-top box and the second set-top box are connected.

Similarly, when a network switch of the present invention receives content intended for group ID2, identified by information communicated with the content, the network switch examines the information communicated with the content and determines that the content is intended for group ID2. Because the network switch contains information identifying which receivers belong to which groups, the network switch determines which receivers belong to group ID2 and, in the above described example, multicasts the content out of a physical port of the network switch on which the third set-top box and the fourth set-top box are connected.

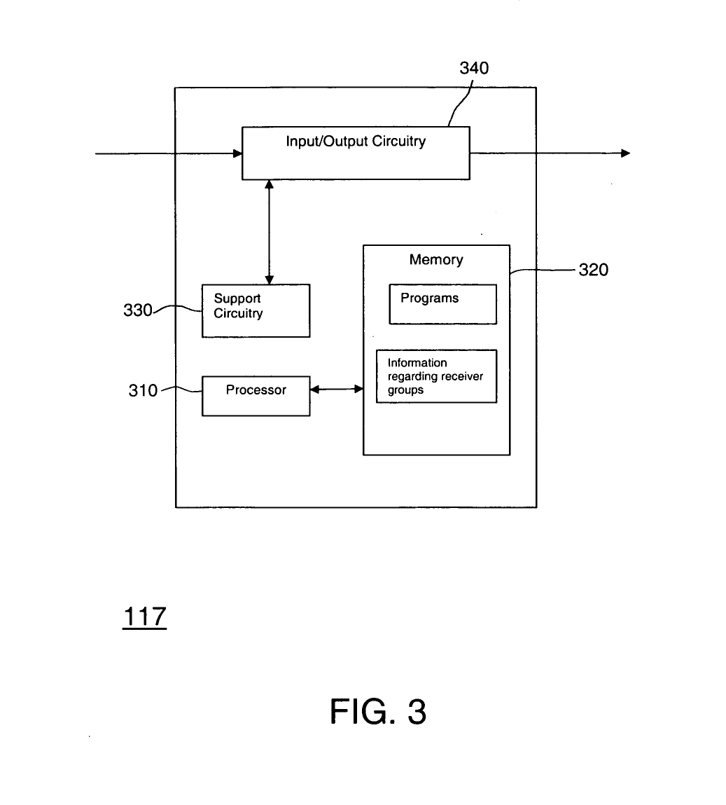

FIG. 3 depicts a high level block diagram of a DGCP device 117 in accordance with an embodiment of the present invention. The DGCP device 117 of FIG. 3 illustratively comprises a processor 310 as well as a memory 320 for storing control programs, applications, command sets, receiver group information and the like. The processor 310 cooperates with conventional support circuitry 330 such as power supplies, clock circuits, cache memory and the like as well as circuits that assist in executing the software routines stored in the memory 320. As such, it is contemplated that some of the process steps discussed herein as software processes may be implemented within hardware, for example, as circuitry that cooperates with the processor 310 to perform various steps. The DGCP device 117 of FIG. 3 also contains input-output circuitry 340 that forms an interface between the various respective functional elements communicating with the DGCP device 117, such as the network switch 115.

Although the DGCP device 117 of FIG. 3 is depicted as a general purpose computer that is programmed to perform various control functions in accordance with the present invention, the invention can be implemented in hardware, for example, as an application specified integrated circuit (ASIC). As such, the process steps described herein are intended to be broadly interpreted as being equivalently performed by software, hardware, or a combination thereof. In addition, although the DGCP device 117 of FIG. 3 is depicted as being integrated into the network switch 115 of the present invention, in alternate embodiments of the present invention, the DGCP device 117 can simply comprise a memory of a network switch or can comprise a separate component in functional communication with a network switch for performing the inventive aspects of the various described embodiments of the present invention.

In an alternate embodiment of the present invention, in addition to having the capability of receiving and storing information regarding the configuration of the group(s) of receivers and which receivers belong to which group(s), a network switch of the present invention can also determine group information for configuring a specific receiver group or group(s) of receivers. More specifically, in one embodiment of the present invention, intended receivers of communicated content may not be previously pre-established or configured as groups. However, a network switch of the present invention, such as the network switch 115 of FIG. 1, can configure a set of receivers for which content is intended to be considered by the network switch 115 as a group of receivers for multicasting purposes. That is, in an embodiment of the present invention, a DGCP device 117 of the network switch 115 of the present invention can configure a set of receivers, for example a set of receivers that receive the same content on a regular basis, as a group. The network switch 115 can then from then on consider and identify those receivers as a group for multicasting purposes. An identifier for such groups configured by the network switch 115 can then be stored in, for example, the DGCP device 117 of the network switch 115, for multicasting received content to intended receivers using a unique identifier for each group established by the network switch.

In addition, in accordance with an embodiment of the present invention, the unique group identifier established by a network switch can have associated with the identifier the ports on which the intended receivers of that specific group are connected to the network switch, such that when content is intended for a group established by the network switch, the unique group identifier created by the network switch for that group can identify the ports on which the intended receivers of that specific group are connected to the network switch for more efficient multicasting. That is, a network switch would more quickly know on which ports to multicast received content once a group identifier has been identified.

For example, suppose that in the above described example the Fashion Department set-top boxes and Food Department set-top boxes do not comprise pre-established groups. When a network switch of the present invention receives content intended for the first and second set-top box of the Fashion Department on more than one occasion, which can occur because in various embodiments of retail advertising the same content is communicated to receivers based on location, a network switch of the present invention can establish a unique identifier for representing, for example, the first and second set-top boxes of the Fashion

Department as a group and the third and fourth set-top boxes of the Food Department as a different group having respective, unique identifiers. As such, when content is received by the network switch, intended for, for example, the first and second set-top boxes of the Fashion Department, the network switch multicasts the content out of a physical port of the network switch on which the first set-top box and the second set-top box are connected using the unique identifier established by the network switch for representing the Fashion Department receiver group, which can also identify the ports on which the intended receivers are connected for more efficient multicasting as described above.

Similarly, when content is received by the network switch, intended for, for example, the third and fourth set-top boxes of the Food Department, the network switch multicasts the content out of a physical port of the network switch on which the third set-top box and the fourth set-top box are connected using the unique identifier established by the network switch for representing the Food Department receiver group. Again, and as described above, the unique identifier for the group established by the network switch of the present invention can also identify the ports on which the intended receivers are connected for more efficient multicasting as described above.

In one specific embodiment of the present invention, a network switch (or switches) of the present invention can be configured to keep a list of set top box (STB) units and identifiers of a group or groups to which a STB belongs. When content is communicated to a network switch of the present invention intended for a specific group, the network switch can automatically modify a MAC table to forward the desired multicast traffic to all ports with a STB in that group. Such a configuration of the present invention eliminates the delays in waiting for an IGMP message and actually takes processing load off the network switch of the present invention, since the network switch only needs to respond to one command for multicasting the content to all of the STBs of the group instead of many commands to send the content to the individual STBs. Since the network switch can instantly begin forwarding packets to the group of STBs, the packets are much more likely to arrive at each individual STB at the same time, resulting in a tighter synchronization of content playback.

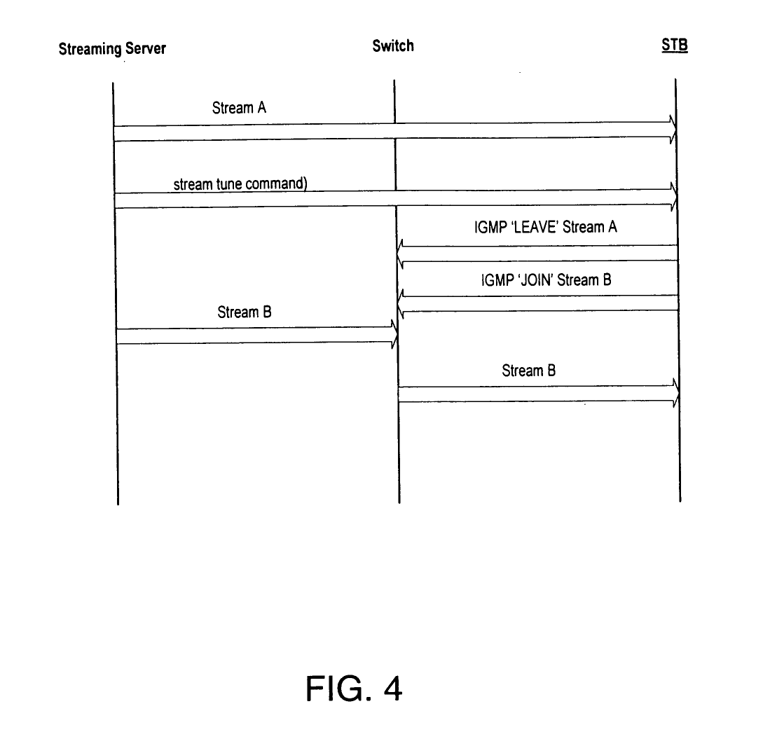

FIG. 4 depicts an example sequence diagram for using a prior art IGMP enabled network switch. As depicted in FIG. 4, the IGMP enabled network switch will not forward multicast streams out of a physical port until it knows that a client on that port has issued a IGMP ‘LEAVE’ command to leave the previous stream and an IGMP ‘JOIN’ (or membership report if using IGMP v3) or until the switch queries for membership. As previously described, this feature is called “IGMP Snooping.” That is, as depicted in FIG. 4, a first stream, A, is communicated to an endpoint, illustratively an STB. A tune command is then communicated to the STB to tune to the first stream. Subsequently, in the case of a prior art network switch, a second stream, B, is communicated to the prior art network switch, which does not forward the second stream to the STB until a client on that port has issued an IGMP ‘JOIN’ or until the switch queries for membership. On one popular network switch, tests have demonstrated approximately 56 ms delay times between the time content reaches the switch and when the content reaches the STB using such techniques. This is equivalent to nearly two video frames and in a retail advertising environment is sufficient a delay to cause serious audio echoes between STB units.

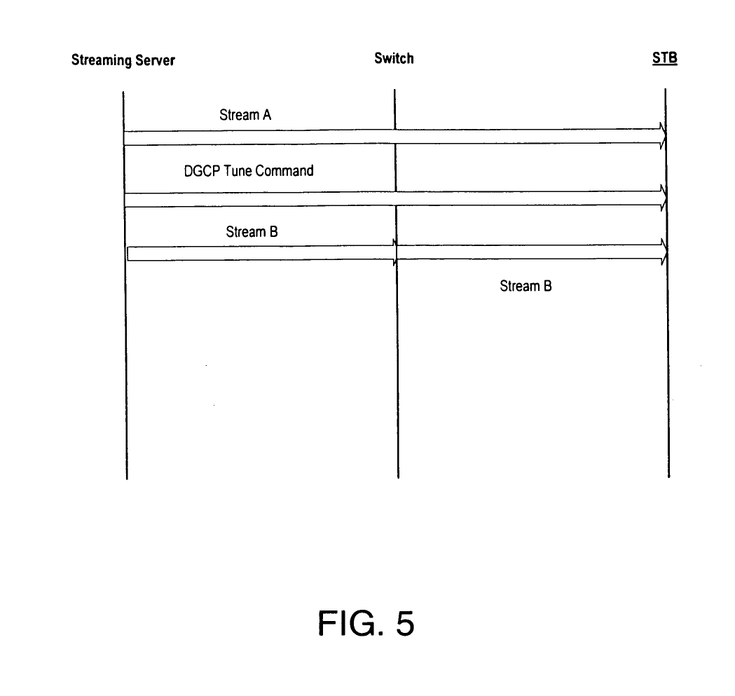

FIG. 5 depicts an example sequence diagram for using an improved multicast network switch in accordance with an embodiment of the present invention. As depicted in FIG. 5, a network switch of the present invention can belong to the DGCP protocol and listens for and responds to a tuning command by forwarding the multicast traffic out of a physical port of the network switch on which a member device (e.g., receiver, STB, etc.) of the group is connected. That is, as depicted in the embodiment of FIG. 5, using the DGCP protocol (e.g., DGCP tune) a stream, A, is communicated to a STB or a group of STBs, the stream including information for which group or groups of receivers the stream is intended. The receivers examine the stream and determine from the information included with the stream if the stream is intended for that receiver. In the case of a network switch of the present invention and as depicted in FIG. 5, again using the DGCP protocol, a stream, B, is communicated to the network switch and intended for a group or group of STBs, the stream again including a unique identifier for identifying which group or groups of receivers the stream is intended. In accordance with the present invention and because the network switch of the present invention has knowledge of which receivers belong to which STB group or groups of STBs for which the stream is intended, the network switch of the present invention communicates the multicast traffic out of a physical port of the network switch on which a member STB(s) of an identified group or groups is connected.

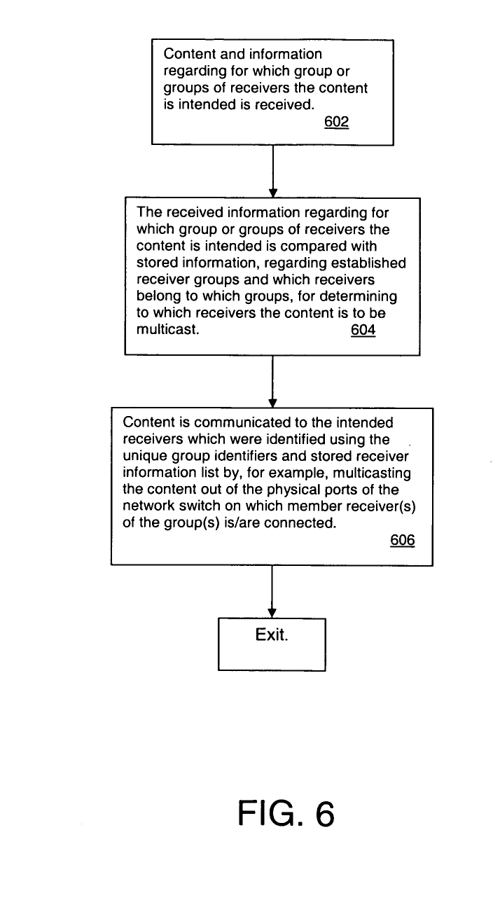

FIG. 6 depicts a flow diagram of a method for an improved multicast network switch in accordance with an embodiment of the present invention. The method 600 of FIG. 6 begins at step 602 during which content and information regarding a group or groups of receivers for which the content is intended is received by the network switch. The method 600 then proceeds to step 604.

At step 604, the received information regarding for which group or groups of receivers the content is intended is compared with stored information regarding established receiver groups and which receivers belong to which groups for determining for which receivers the content is intended. For example, in one embodiment of the present invention in which groups of receivers and unique group identifiers are pre-established (e.g., DGCP), a network switch of the present invention can compare received information regarding for which group or groups of receivers content is intended (i.e., the network switch receives unique group identifiers indicating for which groups of receivers the content is intended) with stored information regarding which receivers belong to which pre-established groups for identifying which ports of the network switch to utilize to multicast the content to the intended receivers of the identified group(s).

In an alternate embodiment and as described above, a network switch of the present invention can establish groups of receivers and group identifiers for the locally established groups based on to which receiver(s) content is communicated. As such, content received in the future for the same group can use the established group identifiers for identifying which ports of the network switch to utilize to multicast the content to the intended receivers of the established group(s). The method 600 proceeds to step 606.

At step 606, content is communicated to the intended receivers which were identified using the unique group identifiers and stored receiver information list by, for example, multicasting the content out of the physical ports of the network switch on which member receiver(s) of the group(s) is/are connected. The method can then be exited.

Having described various embodiments for a method and apparatus for an improved network switch multicast functionality (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. While the forgoing is directed to various embodiments of the present invention, other and further embodiments of the invention may be devised without departing from the basic scope thereof.

1. A method for improved multicast functionality, comprising:
receiving information regarding for which group or groups of receivers content is intended;
comparing said received information with stored information regarding which receivers belong to which group or groups of receivers to identify receivers belonging to said group or groups of receivers for which the content is intended; and
multicasting said content to said identified receivers.

2. The method of claim 1, wherein said information is received with said content.

3. The method of claim 1, wherein said group or groups or receivers are established according to a device group control protocol.

4. The method of claim 3, wherein each group of receivers is distinguished using a unique identifier.

5. The method of claim 1, wherein said content comprises retail advertising content and said receivers comprise at least one of a set-top box, a display and an audio playout device.

6. The method of claim 1, wherein said group information is received from a content source.

7. The method of claim 1, wherein grouping of receivers is established at a location of said stored information.

8. The method of clam 7, wherein the location of said stored information comprises a network switch.

9. The method of claim 1, wherein a group of receivers comprises a single receiver.

10. The method of claim 1, further comprising associating respective ports of a network switch with each group or groups of receivers, the respective ports of each group or groups of receivers identifying which ports of the network switch are in communication with the respective receivers of each group or groups.

11. The method of claim 10, wherein said content is multicast to the identified receivers using the associated ports of the network switch.

12. An apparatus for improved multicast functionality, comprising:
a network switch for communicating received content to intended receivers; and
a device for storing information regarding a grouping or groupings of receivers and which receivers belong to which group or groups of receivers;
wherein said apparatus is configured to:
receive information regarding for which group or groups of receivers content is intended;
compare said received information with said stored information to identify receivers belonging to said group or groups of receivers for which the content is intended; and
multicast said content to said identified receivers.

13. The apparatus of claim 12, wherein said device further establishes said group or groups of receivers.

14. The apparatus of claim 12, wherein said device comprises an integrated component of said network switch.

15. The apparatus of claim 12, wherein said apparatus receives said group information with said content.

16. The apparatus of claim 12, wherein said group or groups or receivers are established according to a device group control protocol.

17. The apparatus of claim 16, wherein each group of receivers is distinguished using a unique identifier.

18. The apparatus of claim 12, wherein said group information is received from a content source.

19. The apparatus of claim 12, wherein grouping of receivers is established at said device.

20. The apparatus of claim 12, wherein respective ports of said network switch are associated with each group or groups of receivers, the respective ports of each group or groups of receivers identifying which ports of the network switch are in communication with the respective receivers of each group or groups.
